(19) United States
(12) Patent Application Publication
(10) Pub. No.: US 2021/0304080 A1
(43) Pub. Date: Sep. 30, 2021

(54) FLIGHT RECOVERY SYSTEM BASED ON FLIGHT VALUE ASSESSMENT

(71) Applicant: Hangzhou Pi-Solution Information Technology Co., Ltd, Hangzhou (CN)

(72) Inventors: Peng DUAN, Hangzhou (CN); Cheng XU, Hangzhou (CN)

(73) Assignee: Hangzhou Pi-solution Information Technology Co.,Ltd, Hangzhou (CN)

(21) Appl. No.: 17/209,685

(22) Filed: Mar. 23, 2021

(30) Foreign Application Priority Data
Mar. 24, 2020 (CN) 202010210589.3

(51) Int. Cl. G06Q 10/02; G06Q 50/14; G06Q 10/10; G06Q 30/06; G06Q 10/00; G06F 16/2457; G06F 16/248; B64D 43/00; B64D 45/00

(52) U.S. Cl. CPC G06Q 10/02; G06Q 50/14; G06Q 10/103; G06Q 30/0629; G06Q 30/0627; B64D 45/00; G06Q 30/0631; G06F 16/24578; G06F 16/248; B64D 43/00; G06Q 10/20

(57) ABSTRACT

A flight recovery system based on flight value assessment includes a flight rating module, a flight value ranking module, a parameter configuration module, a flight alert module, a flight cancellation recommendation module, a flight recovery range selection module, an optimization model configuration module, an optimization result display and comparison module, and an optimization result release module. The flight recovery system based on flight value assessment establishes a unified application platform and data integration platform of the operation field, integrates the applications of operation control center (OCC) peripheral systems, realizes a flexible and scalable architecture with user-friendly GUI, conducts a unified and standardized management on operation data and unifies data standards of the operation data in the operation field, and improves data sharing capabilities.

### CROSS REFERENCE TO THE RELATED APPLICATIONS

This application is based upon and claims priority to Chinese Patent Application No. 202010210589.3, filed on Mar. 24, 2020, the entire contents of which are incorporated herein by reference.

### TECHNICAL FIELD

The present invention relates to the technical field of flight recovery, in particular to a flight recovery system based on flight value assessment.

### BACKGROUND

At present, in addition to the system operation control (SOC) that is known as the peripheral system of the airline operation control center, the airline industry is still applying a large number of peripheral support systems such as operation management information system (OMIS), flight management system (FMS), and aviation fleet production assistant system to fulfill their daily operations, statistics, analysis and other tasks. As various systems existing in airlines environment, a sort of issues may occur such as multiple data sources, inconsistent data standards, and complicated business procedures, which reduce the flight operation efficiency and quality.

### SUMMARY

In order to solve the above problems, the present invention provides a flight recovery system based on flight value assessment. The flight recovery system can integrate the data from different SOC peripheral systems, realize a flexible and scalable architecture with user-friendly GUI. Furthermore, the flight recovery system may conduct a unified and standardized management on operation data, and improve data sharing capabilities.

The technical solutions of the present invention are as follows.

A flight recovery system based on flight value assessment includes:

a flight rating module: be used to provide a user with the function of flight rating and show key attributes of flights;

a flight value ranking module: be used to perform a value ranking on all flights during any time period;

a parameter configuration module: be used to set parameters for the effectiveness of the flight rating module and the flight value ranking module;

a flight alert module: be used to dynamically show a generated alert and allow users to check warnings and alerts any time;

a flight cancellation recommendation module: be used to obtain a recommendation list of flight cancellation for reference of a flight adjustment operator;

a flight recovery range selection module: be used to determine an aircraft type, a tail number or a range of a flight involved in an automatic recovery and generate a flight adjustment result;

an optimization model configuration module: be used to generate an adjustment plan based on an optimization model;

an optimization result display and comparison module: be used to show a flight adjustment plan generated by the optimization model and compare with each other; and

an optimization result release module: be used to release an optimized adjustment plan.

The flight rating module includes: a historical rating module used to rate flights in any time period; a dynamic rating module used to rate a dynamic flight; and a plan rating module used to rate the adjustment plan generated by an airline flight operation system.

The steps of implementing the function of the flight value ranking module include:

selecting “value ranking” by the user;

specifying, by the user, a date range of flights that need to be subjected to the value ranking;

adding a search and filter in the value ranking, wherein the search and filter includes an aircraft type and a takeoff and landing airport;

getting relevant attributes of all flights within the date range and providing them to a background model for calculation; and

showing a value ranking result.

Flight value ranking module includes:

a dynamic single flight airline maintenance module: be used to add, delete, modify and check a dynamic single flight airline;

a customized important flight maintenance module: be used to add, delete, modify and check a customized important flight;

a predefined high-income flight maintenance module: be used to add, delete, modify and check a predefined high-income flight;

a high compensation flight maintenance module: be used to add, delete, modify, and check a high compensation flight; and

a supplementary flight maintenance module: be used to add, delete, modify and check a supplementary flight.

The parameter configuration module includes:

an action setting module: be used to set rates of various rating items according to adjustment actions of the flight;

a value setting module: be used to set rates of various value items according to the value of the flight.

The flight alert module includes a Gantt chart alert module and an operation control alert module. The function of the Gantt chart alert module includes: visually viewing the content of each alert; quickly locating the corresponding flight and the flight that conflicts with it; manually ignoring alerts so that alerts will not be triggered again; filtering alert records at any time according to user requirements. The function of the operation control alert module includes: setting a separate alert list interface for user monitoring and subsequent processing; filtering alerts records at any time according to user requirements; manually ignoring alerts so that alerts will not be triggered again; all users to manually resolve alerts; allowing the user to trigger the entire flight recovery process as the starting point of the flight recovery process.

The specific steps of implementing the function of the flight cancellation recommendation module include: rating the flight according to a rating judgment logic used by the airline first-line flight adjustment operator, and obtaining the recommendation list of flight cancellation based on a calculation conducted by a column generation algorithm and a heuristic rule for the reference of the first-line adjustment operator, wherein the principle of rating is to attach value on the flight through the positive and negative rate mode of the flight, the more negative rates, the higher cancellation priority.

The specific steps of implementing the function of the flight recovery range selection module include: determining, by the user, the aircraft type, the tail number and range of the flight involved in the automatic recovery if the user decides to perform the flight recovery, and deciding, by the user, whether to adjust across different aircraft types; selecting, by the background model, part of the tail number or flight to participate in the calculation if the user does not make a selection.

The specific steps of implementing the function of the optimization model configuration module include: rating the flight adjustment result according to a predefined flight operation benefit assessment model, and selecting the corresponding parameter configuration plan according to different adjustment strategies set in advance.

The specific steps of implementing the function of the optimization result release module include: generating an adjustment plan, and publishing the adjustment plan to the airline flight operation system, writing the plan back to the flight operation system and validating the adjustment plan after manual fine-tuning, and returning the result of the adjustment plan to the existing command system or a third-party system.

The advantages of the present invention are as follows. The present invention provides a flight recovery system based on flight value assessment, which establishes a unified application platform and data integration platform of operation field, integrates the data from SOC peripheral systems, realizes a flexible and scalable architecture with user-friendly GUI, conducts a unified and standardized management on operation data and unifies data standards of the operation data in the operation field, and improves data sharing capabilities.

### BRIEF DESCRIPTION OF THE DRAWINGS

FIG. 1 is a block diagram showing the modules of the flight recovery system in the embodiment of the present invention.

FIG. 2 is a block diagram showing the work flow in the embodiment of the present invention.

### DETAILED DESCRIPTION OF THE EMBODIMENTS

The embodiments of the present invention will be described in detail below with reference to the drawings.

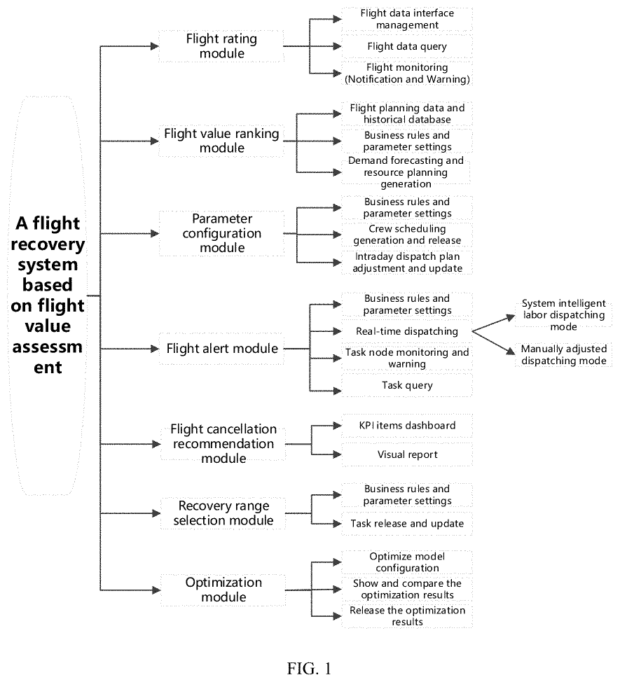

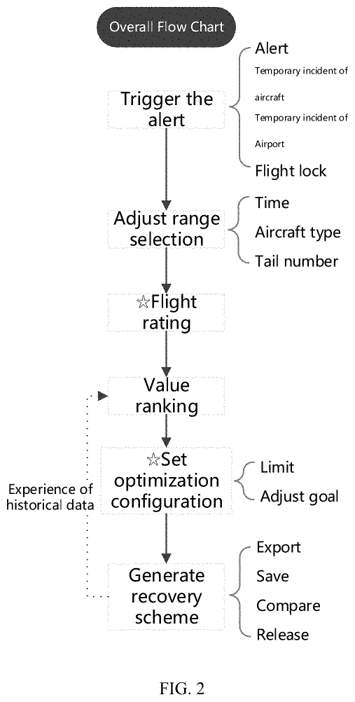

As shown in FIG. 1 and FIG. 2, the system provided by the embodiment of the present invention includes a flight rating module, a flight value ranking module, a parameter configuration module, a flight alert module, a flight cancellation recommendation module, a flight recovery range selection module, an optimization model configuration module, an optimization result display and comparison module, and an optimization result release module.

The flight rating module is used to achieve flight rating and show key attributes of the flight, such as international, long-distance, VIP, cabin value and so on.

A pre-module: be used to access to flight adjustment data, the adjustment data includes flight schedule dynamic data and some attribute data, these data are derived from the airline flight operation system and are accessed by direct database connection, Web Service or MQ.

The flight rating module includes a historical flight rating module, a dynamic flight rating module, and a plan rating module.

The specific steps of implementing the function of the historical rating module include:

rating, by the user, the flights of any time period;

specifying, by the user, the date range to be rated;

getting all adjustment actions and status data of all flights within the date range, and providing them to the background model for calculation; and

showing the rating result.

The specific steps of implementing the function of the dynamic rating module include:

after flight, manually rating by the user;

after flight, automatically rating by the system according to the planned task;

delimiting the scope of the dynamic flight;

getting all adjustment actions and flight status data of flights within the scope, and providing them to the background model for calculation; and

showing the rating result.

The specific steps of implementing the function of the plan rating module include:

fetching the adjustment plan of the airline flight operation system;

analyzing the adjustment plan to obtain the adjustment actions, the status data before the flight adjustment, and the status data after the flight adjustment;

displaying on the Gantt chart to assist making decisions, in which only changed flights and tail numbers are displayed, and remaining flights can be automatically hidden;

delivering the adjustment plan to the background model for rating; and

showing the rating result.

The flight value ranking module: the pre-module is the flight value rate configuration and the flight attribute configuration, wherein the value rate is derived from the aforementioned flight rating module, and the flight attribute data comes from the airline flight allocation system.

The present invention also provides the flight value ranking module, the value ranking process is:

selecting, by the user, “value ranking”;

specifying, by the user, the date range of flights that need to be subjected to the value ranking;

adding a search and filter in the value ranking, wherein the search and filtering condition includes an aircraft type and a takeoff and landing airport;

getting relevant attributes of all flights within the date range and providing them to the background model for calculation; and

showing the value ranking result.

The flight value ranking module includes: an intraday single flight airline maintenance module which is used to add, delete, modify and check an intraday single flight airline, a customized important flight maintenance module which is used to add, delete, modify and check a customized important flight, a predefined high-income flight maintenance module which is used to add, delete, modify and check a predefined high-income flight; a high compensation flight maintenance module which is used to add, delete, modify, and check a high compensation flight; a supplementary flight maintenance module which is used to add, delete, modify and check a supplementary flight.

The system also provides the parameter configuration module, which is used to set parameters for the flight rating module and the flight value ranking module.

The parameter configuration module includes:

an action setting module: used to set rates of various rating items according to the adjustment actions of the flight;

a value setting module: used to set rates of various value items according to the value of the flight.

The present invention also provides the flight alert module, which is used to dynamically show the generated alerts and support users to view alerts information at any time.

The pre-module: used to access to various types of restricted data and attribute data.

The flight alert module includes a Gantt chart alert module and an operation control alert module, and alerts are used to determine whether there is a violation of the flight scheduling or flight dynamic by restricting data.

In the Gantt chart alert module, alert list in the Gantt chart can be opened to visually show the content of each alert, and the corresponding flight and the flight that has conflicts. The user can manually ignore alerts and the alarm ignored by the user will not be triggered again, and alert records can be filtered at any time according to user requirements.

The operation control alert module is used by the first-line flight adjustment operators for the operation control, it needs to eliminate all alert records in the flight alert list, therefore, the following requirements need to be met:

a separate alert list interface should be provided for user monitoring and subsequent alert processing;

alert records can be filtered at any time according to user requirements;

the user can manually ignore the alert, and alerts ignored by the user will not be triggered again, that is, the awareness function, and an “acknowledge” button is added to the list;

the user can manually resolve the alert;

the user can trigger the entire flight recovery process as the starting point of the flight recovery process.

The system also provides the flight cancellation recommendation module, which is used to obtain a recommendation list of flight cancellation, wherein the recommended result is judged based on the flight value and is for the reference of the flight adjustment operator.

The pre-module: used to access to flight data and passenger data, the data all come from the airline flight operation system.

According to the rating judgment logic used by the airline first-line flight adjustment operators, a series of rating is performed on the flight, the recommendation list of flight cancellation is obtained for the reference of the first-line adjustment operators.

The principle of rating is to attach value on the flight through the positive and negative rate mode of the flight, the more negative rates, the higher cancellation priority.

The present invention also provides the flight recovery range selection module, which is used to determine the aircraft type, tail number or range of the flight involved in the automatic recovery and generate a flight adjustment result.

When the user decides to perform the flight recovery, the first thing that needs to be done is to determine the aircraft type, tail number or range of the flight involved in the automatic recovery; the user can select the tail number or flight that he wants to participate in the calculation, and even decide whether to adjust across different aircraft types; if the user does not make a selection, the background model will automatically select part of the tail number and flight to participate in the calculation.

The present invention also provides the optimization model configuration module, which is used to rate the flight adjustment result according to a predefined flight operation benefit assessment model, select the corresponding parameter configuration plan according to different adjustment strategies set in advance, and generate the adjustment plan of the flight recovery, after the flight recovery range selection module selects the flight recovery range.

The calculated plan must first fulfill compliance requirements (hard constraints), and at the same time, it is a balanced adjustment plan that meets certain preferences, such as delay costs, passenger recovery costs, corporate credibility loss, the plan recovery speed and the cost of the aircraft.

The present invention also provides the optimization result display and comparison module, which is used to show and compare the adjustment plan generated after the optimization performed by the optimization model.

The optimization result display and comparison module includes two functions of optimization result display and optimization result comparison. The optimization result display is to perform optimization calculations using multi-dimensional analysis under the premise of meeting safety requirements. For example, if a hub airport is temporarily closed due to bad weather, the optimization calculation process can give a preference adjustment plan within 10 minutes, and the preference adjustment plan can be shown in the Gantt chart. The optimization result comparison function can more visually compare the advantages and disadvantages of the adjustment plans generated by different methods, and recommend multiple plans.

The present invention also provides the optimization result release module, which is used to release the adjustment plan after the optimization performed by the optimization model, and publish the adjustment plan to the airline flight operation system, write the plan back to the flight operation system and validate the adjustment plan after manual fine-tuning, and return the result of the adjustment plan to the existing command system or a third-party system to complete the entire flight recovery process.

The above descriptions are only the embodiments of the present invention, the common knowledge such as the specific structures and characteristics that are well-known in the art is not described here. Those of ordinary skill in the art know all the ordinary technical knowledges in the technical field of the invention before the filing date or priority date, and they can learn all the existing technologies in the field, and have the ability to apply conventional experimental methods before the date. Those of ordinary skill in the art can improve and implement this solution combining their own abilities in light of the teachings given in this application. Some typical well-known structures or well-known methods should not be the obstacles for those of ordinary skill in the art to implement this application. It should be pointed out that for those skilled in the art, without departing from the structure of the present invention, several modifications and improvements can be made, these should also be regarded as the protection scope of the present invention, and these will not affect the effect of the present invention and the practicability of the patent. The scope of protection claimed in this application shall be subject to the content of the claims, and the description of the specific embodiments in the specification can be used to interpret the content of the claims.

What is claimed is:

1. A flight recovery system based on a flight value assessment, comprising:
a flight rating module, configured to provide a user with a function of flight rating and show key attributes of a plurality of flights;
a flight value ranking module, configured to perform a value ranking on the plurality of flights in a time period;
a parameter configuration module, configured to set parameters for effectiveness of the flight rating module and the flight value ranking module;
a flight alert module, configured to dynamically show a generated alert, and permit the user to view alert information at any time;
a flight cancellation recommendation module, configured to obtain a recommendation list of a flight cancellation for a reference of an airline first-line flight adjustment operator;
a flight recovery range selection module, configured to determine an aircraft type, a tail number or a range of a first flight of the plurality of flights and generate a flight adjustment result, wherein the first flight is involved in an automatic recovery;
an optimization model configuration module, configured to generate flight adjustment plans based on an optimization model;
an optimization result display and comparison module, configured to show the flight adjustment plans generated by the optimization model and compare the flight adjustment plans with each other; and
an optimization result release module, configured to release an optimized adjustment plan.

2. The flight recovery system according to claim 1, wherein
the flight rating module comprises:
a historical rating module configured to rate the plurality of flights in the time period;
a dynamic rating module configured to rate a dynamic flight, wherein the dynamic flight ends on a day; and
a plan rating module configured to rate an adjustment plan generated by an airline flight operation system.

3. The flight recovery system according to claim 1, wherein
steps of implementing a function of the flight value ranking module comprise:
selecting, by the user, the value ranking;
specifying, by the user, a date range of the plurality of flights to be subjected to the value ranking;
adding a search and filter in the value ranking, wherein the search and filter comprises the aircraft type and a takeoff and landing airport;
getting relevant attributes of the plurality of flights within the date range and providing the relevant attributes to a background model for a calculation; and
showing a value ranking result.

4. The flight recovery system according to claim 3, wherein
the flight value ranking module comprises:
a dynamic single flight airline maintenance module configured to add, delete, modify and check a dynamic single flight airline;
a customized important flight maintenance module configured to add, delete, modify and check a customized important flight;
a predefined high-income flight maintenance module configured to add, delete, modify and check a predefined high-income flight;
a high compensation flight maintenance module configured to add, delete, modify, and check a high compensation flight; and
a supplementary flight maintenance module configured to add, delete, modify and check a supplementary flight.

5. The flight recovery system according to claim 1, wherein
the parameter configuration module comprises:
an action setting module configured to set rates of a plurality of rating items according to adjustment actions of each of the plurality of flights; and
a value setting module configured to set rates of a plurality of value items according to a value of each of the plurality of flights.

6. The flight recovery system according to claim 1, wherein
the flight alert module comprises a Gantt chart alert module and an operation control alert module;
a function of the Gantt chart alert module comprises:
visually viewing a content of the generated alert;
quickly locating a second flight corresponding to the generated alert and a third flight among the plurality of flights, wherein the third flight conflicts with the second flight;
manually ignoring the generated alert to enable the generated alert not to be triggered again; and
filtering alert records at any time according to requirements of the user;
a function of the operation control alert module comprises:
setting a separate alert list interface for user monitoring and subsequent alert processing;
filtering alert records at any time according to the requirements of the user;
manually ignoring the generated alert to enable the generated alert not to be triggered again;
manually resolving the generated alert by the user; and
triggering an entire flight recovery process as a starting point of the entire flight recovery process by the user.

7. The flight recovery system according to claim 1, wherein
steps of implementing a function of the flight cancellation recommendation module comprise:
rating the plurality of flights according to a rating judgment logic used by the airline first-line flight adjustment operator, and
obtaining the recommendation list of the flight cancellation based on a calculation conducted by a column generation algorithm and a heuristic rule for the reference of the airline first-line adjustment operator, wherein
a principle of rating comprises:
attaching a value on each of the plurality of flights through a positive rate mode and a negative rate mode of the plurality of flights, wherein when a number of negative rates increases, a cancellation priority increases.

8. The flight recovery system according to claim 1, wherein
steps of implementing a function of the flight recovery range selection module comprise:
determining, by the user, the aircraft type, the tail number or the range of the first flight involved in the automatic recovery if the user decides to perform a flight recovery, and deciding, by the user, whether to adjust across different aircraft types; and
automatically selecting, by a background model, a part of the tail number or the plurality of flights to participate in a calculation if the user does not make a selection.

9. The flight recovery system according to claim 1, wherein
steps of implementing a function of the optimization model configuration module comprise:
rating the flight adjustment result according to a predefined flight operation benefit assessment model, and
selecting a parameter configuration plan according to different adjustment strategies set in advance to generate flight adjustment plans of a flight recovery.

10. The flight recovery system according to claim 1, wherein
steps of implementing a function of the optimization result release module comprise:
generating the flight adjustment plans according to a recovery result calculated by the optimization model, and publishing the flight adjustment plans to an airline flight operation system;
writing the flight adjustment plans back to the airline flight operation system and validating the flight adjustment plans after manual fine-tuning; and
returning a result of the flight adjustment plans to an existing command system or a third-party system.
